(19) United States
(12) Patent Application Publication
(10) Pub. No.: US 2025/0225202 A1
(43) Pub. Date: Jul. 10, 2025

(54) System and Methods for Enhanced Predictive Power by Noise Suppression Classifiers and Machine Learning

(71) Applicant: OTraces, Inc., Gaithersburg, MD (US)

(72) Inventors: Keith Lingenfelter, Potomac, MD (US); Galina Krasik, Montgomery Village, MD (US)

(21) Appl. No.: 18/799,780

(22) Filed: Aug. 9, 2024

Related U.S. Application Data
(60) Provisional application No. 63/531,738, filed on Aug. 9, 2023.

(51) Int. Cl. G06F 17/18; G06F 5/01

(52) U.S. Cl. CPC G06F 17/18; G06F 5/01

(57) ABSTRACT

This disclosure relates to methods for improving the accuracy of supervised machine learning for classification of complex data where a binary outcome prediction is desired from a multitude of independent variables that generally relate to the outcomes but are not highly specific in prediction. These methods are used in biology and in the physical world to determine likely outcomes based upon carefully selected input information termed independent variables. Classification is defined as the process of recognition, understanding, and grouping of objects and ideas into preset categories a.k.a. “sub-populations.” With the help of these pre-categorized training datasets, classification in machine learning programs leverage a wide range of algorithms to classify future datasets into respective and relevant categories. Supervised machine learning involves using a predetermine data set of independent variables with known outcomes to be used as training set for the process of building the predictive model.

### CROSS-REFERENCE TO RELATED APPLICATIONS

This application claims the benefit of U.S. Provisional Application No. 63/531,738, filed Aug. 9, 2023, the entirety of which is hereby incorporated by reference herein.

### FIELD OF THE INVENTION

The present invention relates to systems and methods for improving the accuracy of supervised machine learning for classification of complex data where a binary outcome prediction is desired from a multitude of independent variables that generally relate to the outcomes but are not highly specific in prediction.

### BACKGROUND OF THE INVENTION

Methods are used in biology and in the physical world to determine likely outcomes based upon carefully selected input information termed independent variables. Classification is defined as the process of recognition, understanding, and grouping of objects and ideas into preset categories a.k.a. “sub-populations.” With the help of those pre-categorized training datasets, classification in machine learning programs leverage a wide range of algorithms to classify future datasets into respective and relevant categories. Supervised machine learning involves using a predetermine data set of independent variables with known outcomes to be used as training set for the process of building the predictive model.

Diagnostic medicine has long held promise that proteomics, the measurement of multiple biomarkers with a classification/machine learning technology, would yield break-through diagnostic methods in diseases for which research heretofore has not produced simple viable blood tests. Likewise, classification solutions in fields in finance prediction, image classification, recognizing handwritten characters, and possibly text and hypertext classification have held hope of solutions that will yield accurate predictive results using such a classifier-based model, with machine learning algorithms. Cancer and Alzheimer's are just two in the biology field. A major problem has, in large part, boiled down to independent sample variables that are contaminated with factors related to other conditions or that reflect environmental influences on the values of those variables. For example, in biology, within a large population with known disease and not-disease states that would be used as the basis of a model to assess exercising the classifier, there exists hundreds if not thousands of the conditions or drugs that affect up or down regulation of the biomarkers of choice. Furthermore, biological systems exhibit complex non-linear behaviors that are exceedingly difficult to model in a classification (machine learning) type method. Those complicating factors exist in other predictive modeling situations outside of biology such a finance-based modeling. Presented here are systems and methods for improving this predictive power of such modeling that outperforms currently available classifier methods. The new technology involves mathematically processing the raw independent variables such that truth is maintained, and specificity problems are significantly reduced.

This disclosure discloses novel systems and methods as described below. Related U.S. Pat. No. 11,699,527, “A Method for Improving Disease Diagnosis Using Measured Analytes,” and U.S. Pat. No. 11,694,802, “Systems and Methods for Improving Disease Diagnosis,” for methods related to treating metabolic diseases generally, are incorporated by reference herein in their entireties.

This disclosure covers all classifier applications in biology as well as disclosures outside of biology including but not limited to finance, physics, population opinion type issues, imaging problems, etc.

### BRIEF SUMMARY OF THE INVENTION

The present invention comprises systems and methods using an evaluative model to indicate a probability of a Classifier Outcome for a Classifier Condition Under Evaluation in a Sample Under Evaluation under examination. The techniques involve receiving a first set of CSC Independent Variable values of a first data point from the Classifier Condition Under Evaluation from a first set of samples from Samples Under Evaluation with a Classifier State “B” for the Classifier Condition Under Evaluation and also receiving a second set of CSC Independent Variable values of the first data point from the Classifier Condition Under Evaluation from a second set of samples from Samples Under Evaluation with a Classifier State “A” for the Classifier Condition Under Evaluation, wherein the first set and second set of samples comprise a training set of samples. The techniques also involve calculating a mean value of the CSC Independent Variable values of the first data point from the Classifier Condition Under Evaluation from the first set of CSC Independent Variable values, as well as calculating a mean value of CSC Independent Variable of the first data point from the Classifier Condition Under Evaluation from the second set of CSC Independent Variable values. The techniques also include computing a midpoint value of CSC Independent Variable between the mean value of the first set of CSC Independent Variable values and the mean value of the second set of CSC Independent Variable values, and calculating a first proximity score representing the mean value of CSC Independent Variable of the first set of data points from the Classifier Condition Under Evaluation, said calculation comprising normalizing FCSI Independent Variable drift in transition between the Classifier Outcome for the Classifier Condition Under Evaluation and non-disease state for the Classifier Condition Under Evaluation and dampening outlier CSC Independent Variables in the training set of samples. The techniques may further include calculating a second proximity score representing the mean value of CSC Independent Variable of the second set of data points from the Classifier Condition Under Evaluation, where the calculations comprise normalizing FCSI Independent Variable drift in transition between the Classifier Outcome for the Classifier Condition Under Evaluation and non-disease state for the Classifier Condition Under Evaluation and dampening outlier CSC Independent Variables in the training set of samples. The techniques also include deriving a midpoint proximity score representing the derived midpoint of the mean values of CSC Independent Variable of the first and second sets of data points from the Classifier Condition Under Evaluation, and mapping the CSC Independent Variables of the training set of samples into a range of proximity scores between the first proximity score and the second proximity score to complete the evaluative model. The evaluative model identifies the Classifier Outcome for the Classifier Condition Under Evaluation of a Sample Under Evaluation under examination.

In some embodiments, the training set of samples includes at least one of blood samples, urine samples, and tissue samples.

In certain embodiments, the calculated mean value for CSC Independent Variable for the first set of samples and for the second set of samples is FCSI Independent Variable-adjusted.

In yet other embodiments, the training set of samples includes an equal number of State “A” samples and State “B” samples.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a scatter diagram of raw concentration VEGF and IL-6, in breast cancer;

FIG. 2 is a scatter diagram of VEGF and Il-6 proximity scores after processing;

FIG. 3 is a 3D scatter diagram of breast cancer proximity score IL-6, IL-8, and VEGF with a straight-on view;

FIG. 4 is a 3D scatter diagram of breast cancer proximity score, IL-6, IL-8 and VEGF rotated right 75 degrees;

FIG. 5 is a 3D scatter diagram of breast cancer proximity score, IL-6, IL-8 and VEGF rotated up 25 degrees;

FIG. 6 is a scatter diagram of the proximity score vs. concentration breast cancer, showing the full equation set for the BC Model;

FIG. 7 is a graph showing the zoned log concentration conversion to proximity scores;

FIG. 8 is a graph showing proximity score conversion showing zone fold over and multiple ages for IL-6;

FIG. 9 is a scatter diagram showing a bimarker plot for cancer and not-cancer data points for VEGF and IL-6;

FIG. 10 is a scatter diagram showing a bimarker plot for melanoma for IL-8 and EGF;

FIG. 11 is a scatter diagram showing a bimarker plot for diabetes biomarkers;

FIG. 12 is a scatter diagram showing a bimarker plot for credit card fraud determinations; and

FIG. 13 is a graph showing the effect of age on the identification of diabetes in a population.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in a similar manner to accomplish a similar purpose. Several preferred embodiments of the invention are described for illustrative purposes, it being understood that the invention may be embodied in other forms not specifically shown in the drawings.

### Definitions

“Bi-marker Plane” is a set of two raw independent variables or Proximity Scores that are normalized and functionally related to a meta-variable's variation with respect to the independent variable's transition from the binary classifier outcome predictions State “A” to State “B” or State “A” to not State “A”. For the biological classifier case it would the biomarker transition from a non-disease to a disease state when plotted in a two axis graph (or grid), and referred to below as “bi-marker planes.”

“Biological Sample”: In biology, it means tissue or bodily fluid, such as blood, plasma, urine, or saliva, that is drawn from a patient subject and from which the concentrations or levels of diagnostically informative analytes (also referred to as markers or biomarkers) may be determined.

“Biomarker” means a biological constituent of a subject's biological sample, which is typically a protein, peptide, metabolomic analyte, RND or DNA measured in a bodily fluid such as a blood serum, plasma, urine, or saliva. Examples include cytokines, tumor markers, age, height, eye color, or geographic factors and the like. What is important is that such measurements or attributes vary within a population and are measurable, determinable, or observable.

“Blind Sample” is a test sample of the data set for the Classifier Condition Under Evaluation where all the independent variable (CSC and FCSI, see below) information is available but there is no information on the true Classifier Outcome. In biology, it is a biological sample drawn from a subject without a known classifier outcome state or diagnosis of a given disease, and for whom a prediction about the presence or absence of that disease is desired. The objective of the Classifier Training set model is to predict the correct true Classifier Outcome. In biology this would predicting the disease state or the efficacy of a drug or other outcome to better further the treatment of the patient.

“Classifier Condition Under Evaluation” is the situation or condition that the classifier is intended to define or predict for the multitude of CSC and FCSI Independent Variables (see below). In biology this maybe the status of or presence of a disease or a prediction of the efficacy of a drug on a particular patient with certain set of attributes that are generally embodied in the independent variables to the classifier. In the physical world it can be any situation where knowledge of likely outcome has value or interest. In this disclosure, airline passenger satisfaction and the likelihood of a credit card transaction being fraud is evaluated.

“Classifier Outcome” is the binary prediction of the outcome state of an unknown sample when using a training set with machine learning to make the prediction with a multitude of independent variables as inputs to the machine learning classifier algorithm(s). In the general case this would be called State “A” or State “B” (or Not State “A”). In the case of a biological prediction this may be a diagnosis of a disease state (yes or no). or perhaps the efficacy of a drug function on the sample of interest. In biology, this may also be the relative severity of the disease.

“Classifier State “A“ ” is one of the Classifier Outcomes of a Classifier Condition Under Evaluation or a binary classifier.

Classifier State “B“ ” is the second of the Classifier Outcomes of a Classifier Condition Under Evaluation or a binary classifier, this state may also be termed Not-Classifier State “A” when the task of the Classifier is to rule in or rule out a Condition Under Evaluation.

“Classifier State Coupled (CSC) Independent Variables”, are variables whose measured value is dependent or effects the classifier outcome state. In the biological case these would be proteins or perhaps metabolites that change in measured value as the disease state changes. These independent variables invariably are affected by other conditions either known or unknown that are present in the sample under evaluation. Thus, they are inherently contaminated by these conditions degrading specificity. They would be termed noisy. These variables can be improved in accuracy by normalizing drift in key values such as the Classifier State mean value and by selected compression anchored by these key mean values.

“CSC compression” is used to suppress information in the RAW CSC Independent Variables that is not of interest in the question at hand, is the unknown sample state “A” or state “B” (or not State “A”). This compression must be applied in a way that maintains the integrity of the “Signature of the Classifier Outcome”

“Disease Related Functionality” is a characteristic of a biomarker that is either an action of the disease to continue or grow or is an action of the body to stop the disease from progressing. In the case of cancer, a tumor will act on the body by requesting blood circulation growth to survive and prosper, and the immune system will increase proinflammatory actions to kill the tumor. These biomarkers contrast with tumor markers that do not have Disease Related Functionality but are sloughed off into the circulatory system and thus can be measured. Examples of Functional Biomarkers would be Interleukin 6 which turns up the actions of the immune system, or VEGF which the tumor secretes to cause local blood vessel growth. Whereas a nonfunctional example would be CA 125. It is a structural protein located in the eye and human female reproductive tract and has no action by the body to kill the tumor or action by the tumor to help the tumor grow. The tumor marker is simply sloughed off into the bio-fluid measured.

“Fixed Classifier State Independent (FCSI) Independent Variables” are variables that are by their nature unaffected by the classifier outcome state, in biology, disease or not disease. In biology, these are at least test sample chronological age, inherited DNA, race, geographical location. In the case, shown in this disclosure, the cash amount of the possible credit card fraud was used as a FCSI Independent Variable in the classifier model developed. This classification of independent variables is important as these variables have been found to have limited predictive power when use directly as an independent variable in the classifier model but have high improvement in predictive power when used as a “metavariable” (see below) to normalize the mean value of CSC Independent Variable drift. In cancer, when used directly as an independent variable ˜0.5% predictive power improvement has been found but when used as a metavariable 4.0% improvement was found.

“Meta-variable” is an independent variable that is not used directly as an input to the classifier but is used to adjust the values of the CSC Independent Variables. The metavariable is used to normalize the drift in the mean values of the CSC Independent Variables related to changes in the metavariable. See “Classifier State Coupled” (CSC) Independent Variables and Classifier

State Independent (FCSI) independent variables above. In this EPPNS method the FCSI variables are used as metavariables and not directly included in the independent variable set operated on by the machine learning operation.

“Normalizing the Independent Variable-CSFI Shift” refers to removing inherent CSFI related shifting of the Classifier outcome transition in the CSC Independent Variable measurements. This “normalizing” action removes the CSFI factor that degrades (by smearing out) the classification of the CSC measurements to outcome predicted transition. This normalization is embodied in the “Proximity Score” variable.

“Normalizing the Midpoint Value of Classifier Outcome Prediction” refers to the value of the independent variable determinations that is the average of the two mean values for the two (binary) classifier outcome predictions for each value of the CSC Independent Variables. For biology, this midpoint would be the average of the two CSFI mean values for disease and not disease, when mapped to Proximity Score the CSC Independent Variable drift of the FCSI Independent Variable measurements is removed.

“Overfitting” occurs when a statistical model fits exactly, or highly accurate against its training data. That can happen when the number of CSC Independent Variables is too high compared to the size of the training set model. In those cases, the model will accurately predict the Training Set outcomes, but it will not work well on generalized samples from the target audience of the Evaluation Model for the Classifier Condition Under Evaluation. That can be guarded against by keeping the size of the training set in proper proportion to the number of CSC Independent Variables¹. The literature reports that the training set model should have at least 20 to 25 samples ¹ Overfitting in prediction models-Is it a problem only in high dimensions?; Jyothi Subramanian, Richard Simon; Contemporary Clinical Trials 36 (2013) 636-641 per outcome side e.g. 25/25 for each CSC Independent Variable. Thus, 5 independent variables should use a training set of at least 100/100 to 125/125 samples.

“Predictive Power” means the average of sensitivity and specificity for a classifier, e.g., in biology a diagnostic assay or test, or one minus the total number of erroneous predictions (both false negative and false positive) divided by the total number of samples.

“Proximity Score” means a substitute or replacement value for the value of a measured CSC Independent Variable and is, in effect, a new independent variable that can be used in a classifier analysis. In biology the Proximity Score is related to and computed from the concentration of measured biomarker analytes, where such analytes have a predictive power for a given disease state. The Proximity Score is computed using a meta-variable adjusted population distribution characteristic of interest to transform the actual measured concentration of the predictive CSC Independent Variable for a given test sample for whom a classification is desired

“Sample Under Evaluation” is a test sample with the data set of the Classifier Condition Under Evaluation. In biology, this maybe a specific patient and otherwise would a specific sample (one) of the samples characterized by the data set and thus relationally related to the Classifier Condition Under Evaluation. For non-biology cases, in this disclosure for credit card fraud, this would be a single case of suspected fraud and all of the date set independent variables associated with this sample.

“Signature of the Classifier Outcome” means the information embodied in the RAW independent variables that is indicative of the outcome states of interest, but that tends to suppress the information in the independent variables that is not of interest to the question in hand. In the biology case, the disease signature may well be a diagnosis of whether a disease state “A” is present or not. In the process of building a training set model, that signature can be obtained. The Signature is three values derived from the training set raw CSC data. It is the mean values of the outcome states, in biology this would be the known mean values of the biomarker for the not disease and disease states. Also, the midpoint between these two derived values. These three data points are the signature. For cases where CSC Independent Variables are to be used, these three values must be derived for each discreet value of the FCSI Independent Variables. Note that these CSC mean values are affected by the FCSI variables.

“Training Set” is a group of samples (200 or more, typically, to achieve statistical significance for the CSC Independent Variables) with known CSFI Independent Variables values, known CSC Independent Variable values and known Outcome States. The training set is used to determine the axes values “Proximity Scores” of the “bi-marker” planes as well as score grid points from the cluster analysis that is used to score individual Blind Samples.

“Training Set Model” is an algorithm or group of algorithms constructed from the training set that allows assessment of Blind Samples regarding the predictive outcome as to the probability that a subject has outcome state “A” or state “B” (or not state “A”), or a patient has a disease or does not have the disease. The “Training Set Model” is then used to compute the scores for Blind Samples to predict classifier outcomes, in biology typically for clinical or diagnostic purposes. For that purpose, a score is provided over an arbitrary range that indicates percent likelihood of outcome state “A” or state “B” (or not state “A”). e.g., for biology, disease or not-disease.

The Classification Problem & Unknowable Complexity

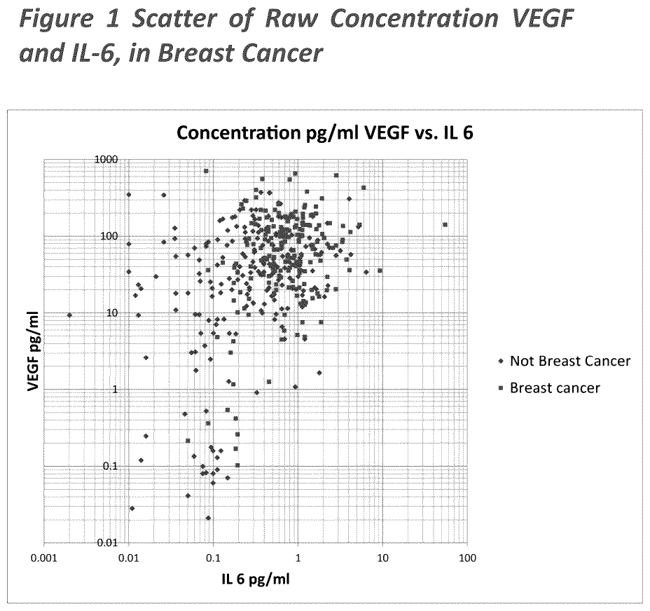

FIG. 1 shows two typical, IL 6 and VEGF, important biomarkers in 400 women that have been diagnosed with breast cancer (red) or not (blue). That plot is typical of hundreds of such plots with other biomarkers where the two states, not-disease and disease are poorly discriminated. That poor discrimination is also endemic in other classification data in fields outside of biology. That poor discrimination is endemic across most, if not all independent variables that could be useful for such classification. There is some upward or downward action of the independent variables as the classification outcome state changes, but the transition is clearly not crisp. The problem with this cancer plot is that most, if not all, of the women in the plot have many conditions unrelated to breast cancer, some possibly known but mostly not known. Many are on prescribed drugs that also affect up or down regulation of these biomarkers. Thus, the plot is contaminated or noisy with unknowable information that confounds the classification of these concentrations to the disease transition². That type of scatter in the data sets is endemic across the field in biology and is common in fields outside of biology. ² The Complexity Paradox (Kenneth L. Mossman, Oxford University Press, 2014), the challenges faced by Proteomic Investigators are aptly summarized: “the non-linear dynamics inherent in complex biological systems leads to irregular and unpredictable behaviors”

28 different public domain machine learning classifiers were analyzed herein, Table 1, Classifier Types, Performance Comparison. None of these can perform as well as the method disclosed in this patent. This method has been called Enhanced Predictive Power by Noise Suppression (EPPNS). Data sets for six cancer diseases and one neurological disease three other diseases and two data sets from the non-biology area for credit card fraud and airline customer satisfaction are shown. As can be seen none of these data sets are as predictive as when the EPPNS method is used for machine learning classification.

TABLE 1
Classifier Types, Performance Comparison
Enhanced Predictive Power by Noise Suppression Classifier (Machine Learning)

| | | | | | | | | Non Small Cell | | | |
|---|---|---|---|---|---|---|---|---|---|---|---|
| | | Breast Cancer | | Ovarian Cancer | | Prostate Cancer | | Lung Cancer | | Pancreatic Cancer | |
| | | Sensi- | | Sensi- | | Sensi- | | Sensi- | | Sensi- | |
| | | tivity/ | Predic- | tivity/ | Predic- | tivity/ | Predic- | tivity/ | Predic- | tivity/ | Predic- |
| | | Speci- | tive | Speci- | tive | Speci- | tive | Speci- | tive | Speci- | tive |
| | | ficity | Power | ficity | Power | ficity | Power | ficity | Power | ficity | Power |
| | | Number of Markers | | | | | | | | | |
| | | 5 | | 5 | | 5 | | 5 | | 6 | |
| Classifier | Classifier | Number of Samples | | | | | | | | | |
| Type | Name | 408 | | 221 | | 441 | | 258 | | 109 | |
| Enhanced | Enhanced Predictive | 96%/97 | 96.5% | 95.5%/ | 95.5% | 99.6%/ | 99.8% | 96.1%/ | 95.4% | 98%/ | 98.0% |
| Predictive | Power Noise | | | 95.5% | | 100% | | 94.6% | | 98% | |
| Power | Suppression | | | | | | | | | | |
| Noise | | | | | | | | | | | |
| Suppression | | | | | | | | | | | |
| | Decrease in Number | | 20 | | 5 | | 5 | | 13 | | 6 |
| | of False Calls EPPNS Vs. | | | | | | | | | | |
| | Common Classifier | | | | | | | | | | |
| Decision Tree | Decision Tree Classifier | | 70.0% | | 67.2% | | 92.4% | | 71.8% | | 80.0% |
| Type | Extra Tree Classifier | | 58.3% | | 68.7% | | 89.7% | | 66.7% | | 60.0% |
| Classifiers | Extra Trees Classifier | | 68.3% | | 77.6% | | 94.9% | | 69.2% | | 86.7% |
| | Random Forest Classifier | | 73.3% | | 74.6% | | 94.5% | | 70.5% | | 90.0% |
| Linear | Linear Discriminant Analysis | | 73.3% | | 68.7% | | 86.6% | | 70.5% | | 76.7% |
| Discriminant | Quadratic | | 68.3% | | 56.7% | | 88.4% | | 70.5% | | 50.0% |
| | Discriminant Analysis | | | | | | | | | | |
| Support Vector | Linear Support | | 73.3% | | 71.6% | | 88.1% | | 75.6% | | 90.0% |
| Machine Type | Vector Classifier | | | | | | | | | | |
| | Nu Support Vector Classifier | | 75.0% | | 73.1% | | 89.4% | | 71.8% | | 80.0% |
| | Stochastic Gradient | | 58.3% | | 67.2% | | 81.0% | | 74.4% | | 63.3% |
| | Descent Classifier | | | | | | | | | | |
| | Support Vector Machine | | 75.0% | | 71.6% | | 94.5% | | 71.8% | | 80.0% |
| Regression | Logistic Regression | | 73.3% | | 70.1% | | 88.1% | | 74.4% | | 80.0% |
| Type | Ridge Classifier | | 73.3% | | 68.7% | | 86.6% | | 70.5% | | 76.7% |
| | Ridge Classifier | | 73.3% | | 67.2% | | 86.6% | | 70.5% | | 76.7% |
| | Cross Validation | | | | | | | | | | |
| Boost | Adaptive Boost Classifier | | 63.3% | | 76.1% | | 94.6% | | 76.9% | | 76.7% |
| Methods | eXtreme Gradient | | 70.0% | | 80.6% | | 94.6% | | 74.4% | | 86.7% |
| | Boost Classifier | | | | | | | | | | |
| | Bagging Classifier | | 66.7% | | 73.1% | | 92.0% | | 71.8% | | 86.7% |
| | Light Gradient | | 68.3% | | 76.1% | | 94.6% | | 74.4% | | 88.0% |
| | Boosting Machine | | | | | | | | | | |
| Label | Label Propagation | | 75.0% | | 61.2% | | 88.2% | | 67.9% | | 76.7% |
| Type | Label Spreading | | 75.0% | | 58.2% | | 88.2% | | 67.9% | | 76.7% |
| | Bernoulli Naïve Bayes | | 76.7% | | 65.7% | | 87.6% | | 71.8% | | 76.7% |
| | Calibrated Classifier | | 71.7% | | 35.8% | | 87.1% | | 73.1% | | 76.7% |
| | Cross Validation | | | | | | | | | | |
| | Dummy Classifier | | 43.3% | | 50.7% | | 50.0% | | 50.0% | | 50.0% |
| | Gaussian Naïve Bayes | | 68.3% | | 56.7% | | 85.6% | | 70.5% | | 83.3% |
| | K Nearest Neighbor | | 71.7% | | 71.6% | | 89.1% | | 71.8% | | 76.7% |
| | Nearest Centroid | | 73.3% | | 61.2% | | 85.7% | | 69.2% | | 73.3% |
| | Passive Aggressive | | 73.3% | | 50.7% | | 76.6% | | 78.2% | | 83.3% |
| | Classifier | | | | | | | | | | |
| | Perceptron Classifier | | 61.7% | | 65.7% | | 89.7% | | 76.9% | | 66.7% |
| | Neural Networks | | 76.4% | | 90.7% | | 95.0% | | 82.0% | | 91.8% |

| | | Melanoma | | Autism | | Lyme's Disease | | Credit Card Fraud | | Airline Satisfaction | |
|---|---|---|---|---|---|---|---|---|---|---|---|
| | | Sensi- | | Sensi- | | Sensi- | | Sensi- | | Sensi- | |
| | | tivity/ | Predic- | tivity/ | Predic- | tivity/ | Predic- | tivity/ | Predic- | tivity/ | Predic- |
| | | Speci- | tive | Speci- | tive | Speci- | tive | Speci- | tive | Speci- | tive |
| | | ficity | Power | ficity | Power | ficity | Power | ficity | Power | ficity | Power |
| | | Number of Markers | | | | | | | | | |
| | | 6 | | 6 | | 5 | | 6 | | 6 | |
| Classifier | Classifier | Number of Samples | | | | | | | | | |
| Type | Name | 550 | | 160 | | 68 | | 320 | | 320 | |
| Enhanced | Enhanced Predictive | 95%/ | 96.0% | 99%/ | 99.0% | 96%/ | 98.2% | 100%/ | 98.4% | 96.9%/ | 96.0% |
| Predictive | Power Noise | 97% | | 99% | | 100% | | 97% | | 95% | |
| Power | Suppression | | | | | | | | | | |
| Noise | | | | | | | | | | | |
| Suppression | | | | | | | | | | | |
| | Decrease in Number | | 3 | | 7 | | 9 | | 3 | | 11 |
| | of False Calls EPPNS Vs. | | | | | | | | | | |
| | Common Classifier | | | | | | | | | | |
| Decision Tree | Decision Tree Classifier | | 92.5% | | 70.0% | | 85.7% | | 77.0% | | 73.96% |
| Type | Extra Tree Classifier | | 80.0% | | 64.0% | | 75.0% | | 75.0% | | 71.88% |
| Classifiers | Extra Trees Classifier | | 91.8% | | 79.0% | | 85.7% | | 90.0% | | 85.42% |
| | Random Forest Classifier | | 92.9% | | 81.0% | | 85.7% | | 89.0% | | 85.42% |
| Linear | Linear Discriminant Analysis | | 88.1% | | 83.0% | | 85.7% | | 85.0% | | 76.0% |
| Discriminant | Quadratic | | 91.0% | | 85.0% | | 50.0% | | 90.0% | | 76.0% |
| | Discriminant Analysis | | | | | | | | | | |
| Support Vector | Linear Support | | 89.7% | | 85.0% | | 82.1% | | 90.0% | | 75.0% |
| Machine Type | Vector Classifier | | | | | | | | | | |
| | Nu Support Vector Classifier | | 91.2% | | 92.0% | | 75.0% | | 85.0% | | 81.3% |
| | Stochastic Gradient | | 78.4% | | 79.0% | | 75.0% | | 86.0% | | 65.6% |
| | Descent Classifier | | | | | | | | | | |
| | Support Vector Machine | | 91.0% | | 90.0% | | 75.0% | | 85.0% | | 81.3% |
| Regression | Logistic Regression | | 89.7% | | 85.0% | | 82.1% | | 88.0% | | 74.0% |
| Type | Ridge Classifier | | 88.8% | | 83.0% | | 89.3% | | 85.0% | | 76.0% |
| | Ridge Classifier | | 89.7% | | 83.0% | | 82.1% | | 85.0% | | 76.0% |
| | Cross Validation | | | | | | | | | | |
| Boost | Adaptive Boost Classifier | | 92.5% | | 83.0% | | 89.3% | | 86.0% | | 76.0% |
| Methods | eXtreme Gradient | | 93.4% | | 85.0% | | 85.7% | | 90.0% | | 78.1% |
| | Boost Classifier | | | | | | | | | | |
| | Bagging Classifier | | 92.5% | | 75.0% | | 85.7% | | 83.0% | | 80.2% |
| | Light Gradient | | 93.2% | | 89.0% | | 75.0% | | 90.0% | | 71.9% |
| | Boosting Machine | | | | | | | | | | |
| Label | Label Propagation | | 86.8% | | 73.0% | | 78.6% | | 85.0% | | 78.1% |
| Type | Label Spreading | | 86.6% | | 73.0% | | 78.6% | | 85.0% | | 78.1% |
| | Bernoulli Naïve Bayes | | 91.4% | | 85.0% | | 82.1% | | 85.0% | | 69.8% |
| | Calibrated Classifier | | 91.3% | | 87.0% | | 85.7% | | 90.0% | | 75.0% |
| | Cross Validation | | | | | | | | | | |
| | Dummy Classifier | | 50.0% | | 50.0% | | 50.0% | | 50.0% | | 50.0% |
| | Gaussian Naïve Bayes | | 90.3% | | 89.0% | | 82.1% | | 89.0% | | 70.8% |
| | K Nearest Neighbor | | 92.3% | | 77.0% | | 78.6% | | 92.0% | | 78.1% |
| | Nearest Centroid | | 88.8% | | 83.0% | | 82.1% | | 87.0% | | 69.8% |
| | Passive Aggressive | | 89.8% | | 66.0% | | 75.0% | | 85.0% | | 78.1% |
| | Classifier | | | | | | | | | | |
| | Perceptron Classifier | | 86.6% | | 72.0% | | 50.0% | | 83.0% | | 70.8% |
| | Neural Networks | | 88.0% | | 88.7% | | N/A | | 95.0% | | N/A |

Highest Public Domain Classifier Highlighted in Bold

Classifier Types

Currently available binary classifier methods generally fall into seven categories

(1) Logistic Regression: This method uses trend lines, logarithmic or linear to derive an outcome classification The data shown in FIG. 1 cannot be modeled for outcome prediction accurately As there is little trending, just scatter

(2) Support Vector Machines: This method uses the construct of a hyperplane that separates the binary outcomes that require prediction. That hyperplane can be flat (linear in two dimensions) or a hyper curved plane in multiple dimensions. The method can also encompass looped hyperplane surfaces for the separation Again, the problem is that there is no pathway through the data set (e.g., VEGF versus Il-6 for cancer) that can perform this separation. It does not matter if the curves are one continuous curved line or are many closed loop type separators.

(3) Simple Bayesian: Naive Bayes classifiers are a collection of classification algorithms based on Bayes' Theorem. It is not a single algorithm but a family of algorithms where all of them share a common principle, i.e., every pair of features being classified is independent of each other. The problem with the FIG. 1 data set is that the independence of the features and how they couple with the outcome yes/no cancer is not independent and the cross reactivity associated with various not cancer disease states will render independence poor.

(4) Decision Tree: A decision tree is like a diagram which people use to represent a statistical probability or find the course of happening, action, or the result. The branches in the diagram of a decision tree show a likely outcome, possible decision, or reaction. The branch at the end of the decision tree displays the prediction or a result. Decision trees are usually used to find a solution for a problem which gets complicated to solve manually.

(5) Nearest Neighbor Cluster: This method uses a simple plot of the independent variables and scores each point by proximity to nearby training set samples. Again, the scatter in FIG. 1 is not conducive to completing this task with high predictive power.

(6) Discriminant Analysis: This method finds the optimum linear or curved lines through the data set. It allows modification of the data set by rotating the bulk of the data set with respect to the axes and shifting the axes up and down reorienting the coordinates position with respect to the bulk of the data set.

(7) Methods that Boost Predictive Power by Combining Methods: The several Boosting methods attempt to improve predictive power by amplification using combined basic classifier methods shown again cannot accurately predict the correct outcome. It is not within the scope of this disclosure to describe in detail these public domain classifiers, nor describe the various categories of such. For further information, these web sites are useful: (1) https://machinelearningmastery.com; (2) https://www.datacamp.com/tutorial/xgboost-in-python; and (3) https://en. wikipedia.org/wiki/Linear discriminant analysis.

Enhanced Predictive Power by Noise Suppression (EPPNS)

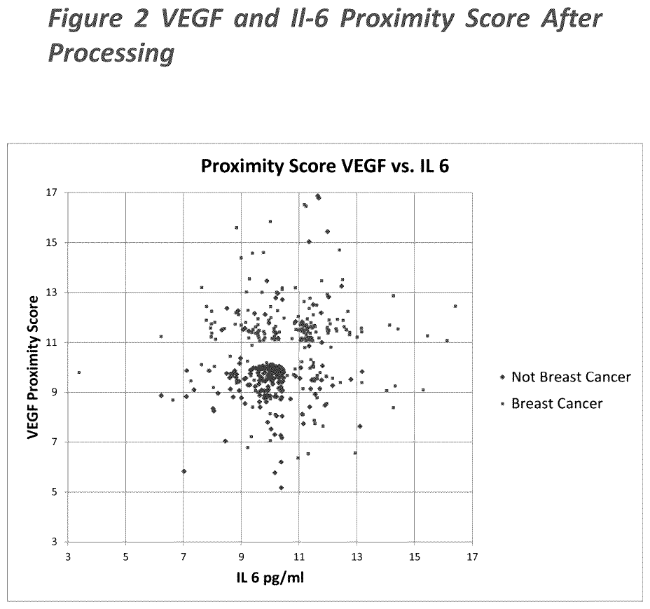

The method disclosed herein is termed “Enhanced Predictive Power by Noise Suppression” (EPPNS). It mathematically modifies the raw independent variables in such a way to suppress information in those variables that is not useful to the classification task of interest. The mathematical actions are designed to maintain information that is useful to the classification task (disease of interest); in this example the classification required is the classification outcome a binary state “A” or state “B” (or not state “A”), based upon information in the independent variables. That method yields FIG. 2, the new set of independent variables, for the breast cancer data set from the Gertsen Institute in Moscow, the same RAW data shown in FIG. 1.

Table 1 shows this EPPNS classifier method compared to several examples, six different cancers, breast, lung, ovarian, prostate pancreatic and melanoma; one neurological disease, Autism; Type 1 Diabetes; one infectious disease, Lyme's; as well as two cases outside of biology, credit card fraud and airline travel satisfaction. Note that the method “Enhanced Predictive Power by Noise Suppression” outperforms all other methods for all cases evaluated by a significant margin.

The problem with all the classical classifier methods, the best of which are typically neighborhood clustering and other complex classifiers, such as Fisher Distinction and Support Vector Machines (SVM,) when used on biological samples is that these biomarkers are severely compromised by a lack of specificity. We call this noise. 2 D plots (two biomarker biplane, e.g., FIG. 1) of any multi-variant data set will look like a scatter gram with slight trending. In biology, the key is to suppress information in the biomarker concentrations that is not related to the question of interest “Is a specific disease present or not?”

The present method uses the neighborhood clustering method for scoring unknown samples by proximity to training set samples. Classifying biological data appears to be far better when scored by multi-dimensional clustering than by data trending (as in Regression methods). However, for this to work well, additional steps must be added by manipulating the raw biomarker measurements. The method adds seven additional steps to the already good classifier, the neighborhood clustering method, also termed Spatial Proximity classification.

First, the available biomarkers are divided into two groups; 1) so called “Classifier State Coupled” CSC Independent Variables. In disease diagnosis, these independent variables (concentrations) are significantly affected by the disease state. These are called “noisy”. In disease diagnosis, these can be proteins, metabolites, peptides, or RNA concentration; and 2) Fixed, Classifier State Independent (FCSI) independent variables, biomarkers in disease classification. These are not affected by the disease but are steady and fixed by the test sample characteristics. These can be age, DNA markers, race, gender, or body mass index. Note that all these CSC and FCSI Independent Variables suffer specificity problems. Table 2 shows the various independent variables and how they are selected for various diseases as well as for the credit card fraud and airline satisfaction cases. Note that some so-called FCSI Independent Variables could also be classified within the SCS variable group depending on the type of condition being analyzed. Body Mass Index could well be classified as CSC for a disease such as type one diabetes as it can negatively affect the BMI. Those situations need classifier analysis to sort out.

TABLE 2
Independent Variable Types, Where Used
Enhanced Predictive Power Specificity with Noise Suppression (EPPNS)

| | | Classifier State Coupled (CSC) | | | | | | |
|---|---|---|---|---|---|---|---|---|
| | | | | | | | | Digitized |
| | | | | | | | Methylated | Surveys, |
| Classifier Target | Classifier Output | Metabolite | Peptide | Protein | RNA | Mutant DNA | DNA | Questionnaires |
| Breast Cancer | Yes/No | | | X | | ✓ | ✓ | |
| Breast Cancer Stage | Stage 1 or2 or 3 or 4 * | | | X | | | | |
| Ovarian Cancer | Yes/No | | | X | | ✓ | ✓ | |
| Prostate Cancer | Yes/No | | | X | | ✓ | ✓ | |
| Non Small Cell Lung Cancer | Yes/No | | | X | | ✓ | ✓ | |
| Pancreatic Cancer | Yes/No | | | X | | ✓ | ✓ | |
| Melanoma | Yes/No | | | X | | ✓ | ✓ | |
| Autism | Yes/No | X | X | | | | | |
| Type One Diabetes | Future Prediction Yes/No | | | X | | | | X |
| Alzheimer's | Yes/No | | | X | | | | |
| Premature Birth/Miscarriage | Future Prediction Yes/No | | | X | | | | |
| Lyme's Disease | No Disease/Positive with | | | X | | | | |
| | Symptoms/Positive without | | | | | | | |
| | Symptoms * | | | | | | | |
| Credit Card Fraud | Yes/No | | | | | | | X |

| | | Fixed, Classifier State Independent (FCSI) | | | | | | |
|---|---|---|---|---|---|---|---|---|
| | | | | Body Mass | Cash | | | |
| | | Natural | | Index | Amount of | | | |
| | | (inherited) | | (Percent | Possible | | Geographical | Menopausal |
| Classifier Target | Classifier Output | DNA | Age | Body Fat) | Fraud | Race | Location | Status |
| Breast Cancer | Yes/No | ✓ | X | | | X | X | X |
| Breast Cancer Stage | Stage 1 or2 or 3 or 4 * | | X | | | X | X | X |
| Ovarian Cancer | Yes/No | | X | | | X | X | |
| Prostate Cancer | Yes/No | | X | | | X | X | |
| Non Small Cell Lung Cancer | Yes/No | | X | | | | | |
| Pancreatic Cancer | Yes/No | | X | | | X | X | |
| Melanoma | Yes/No | | X | X | | X | X | |
| Autism | Yes/No | | X | | | | | |
| Type One Diabetes | Future Prediction Yes/No | X | X | | | | | |
| Alzheimer's | Yes/No | | X | | | | | |
| Premature Birth/Miscarriage | Future Prediction Yes/No | | X | | | | | |
| Lyme's Disease | No Disease/Positive with | | X | | | | | |
| | Symptoms/Positive without | | | | | | | |
| | Symptoms * | | | | | | | |
| Credit Card Fraud | Yes/No | | | | X | | | |

* Indicates use of Binary Classifier in Stages to Predict More than Two Outcomes
Where Variable Found
X indicates OTraces Work
✓ Indicates Other Work in the Field

Next the FCSI Independent Variables, if more than one is used, will be grouped, or “concatenated”. For example, in disease diagnosis, if there are fixed variables such as age and a DNA marker, where age of the test is directed at an age group of 35 to 75 years old and the patients can also exhibit a DNA marker that is related to future probability of contracting the disease, say BRC1/BRC2, DNA markers for risk of breast cancer, This method will require 41 different “fixed” ages and two “fixed” DNA signatures one for yes and one for no. That yields 82 different compression operations one for each concatenated age plus DNA.

In certain embodiments, data is manipulated as follows:

(1) First, the mean values of the classifier outcome for each binary outcome state are found for each of the concatenated FCSI Independent Variables. In this example, this would yield 82 pairs of mean values for each of these states. These are not used directly as independent variables in the EPPNS classifier but are used to normalize the drift in the OSC Independent Variables as the FCSI Independent Variables change patient by patient. Those FCSI Independent Variables are used as a metavariable in the analysis. It is important to note that when age is used as an independent variable in several of the public classifiers the improvement is minimal. E.g., for breast cancer the improvement in predictive power is less than 0.5% with regression classifiers. When age is used in this metavariable method the improvement is about 5%.

(2) The Bi-marker CSC Independent Variable plot space for all CSC Independent Variables is first divided into 4 zones of compression. These zones are defined by the signature of the predicted outcome, e.g., for disease, the mean values of the disease positive and negative samples, for each discrete FCSI Independent Variable. This compression suppresses information in the raw CSC Independent Variable (concentration in biology) that is not important to the question of interest, in this case is Classifier Outcome State “A” present. In this example, the zones are defined by the mean values for Classifier Outcome State “A” and Classifier Outcome State “B” (or Not State “A”) and the derived midpoint between these mean values. In biology that would be disease and not disease. Note the mean values drift with the FCSI Independent Variable set.

(3) The mean values of these CSC Independent Variables may drift with changes in each of the FCSI Independent Variables. Thus, the above noted mean values are determined as a function of each of the FCSI independent variables. In the biology example, for the biomarker VEGF in breast cancer the mean concentration drift overlaps for an age range of 35 to 75 years. That, if not corrected, corrupts the classification.

(4) Finally, a new independent variable for each CSC Independent Variables is computed where a compression algorithm is applied anchored by the means and segregated into each zone, anchored by the mean values for each individual FCSI Independent Variable at that fixed variable value. The family of compression equations is thus a fan of equations one for each FCSI, or combination of FCSI Independent Variables discrete possible values. That creates a new heavily compressed independent variable that has the drift of the mean values by FCSI Independent Variables normalized or removed. Note that it makes no sense to “compress” these so called FCSI Independent Variables. That new independent variable, called Proximity Score, is then plotted in the spatial proximity multi-dimension grid. Unknown samples are scored by proximity to the Training Set samples, after math processing on the unknown samples the same as used on the Training Set.

(5) As outlined previously, methods for improving Classifier Outcome prediction can use a CSC Independent Variable for the classification analysis that is not the CSC Independent Variable of the Sample Under Evaluation (in biology the measured analytes) directly, but rather as a calculated value (Proximity Score) that is computed from the CSC Independent Variable. The Proximity Score is also normalized for certain FCSI Independent Variables (or other physiological parameters) to remove such parameter's negative characteristics such as drift in mean values and non-linearities. Those negative characteristics also include how the concentration values drift or shift with the FCSI Independent Variables (physiological parameters) as the Classifier Outcome (disease state) shifts from Classifier Outcome shift from “A” to “B” (or Not “A”), in biology from healthy to disease. This discussion provides improvements to that method.

Conversion of Raw Independent Variable to the Compressed and Normalized Proximity Score

One equation for conversion of concentration to Proximity Score discussed in the referred application is:

$${PS}_{h} = K * {logarithm}_{10} {( ( Ci / {C}_{( h )} ) - ( {C}_{c} / {C}_{h} ) )}^{2} + Offset \qquad Equation 1$$

$${PS}_{c} = K * {logarithm}_{10} {( ( Ci / {C}_{c} ) - ( {C}_{h} / {C}_{c} ) )}^{2} + Offset \qquad Equation 2$$

Where:
PSₕ+Proximity Score for Outcome State “A”.
PS_{c}=Proximity Score for Outcome State “B” or Not State “A”, which ever applies.
K=gain factor to set arbitrary range.
Cᵢ=determined value (concentration in biology) of the actual sample's CSC Independent Variable.
Cₕ=CSC Independent Variable, (in biology concentration of not-diseased patients' analytes), selected from the family of equations by FCSI Independent Variable value.
C_{c}=CSC Independent Variable, (in biology the concentration of diseased patients' analyte), selected from the family of equations by FCSI Independent Variable value.
Offset=Ordinate offset to set numerical range (arbitrary)

This zone-based compression method is disclosed in U.S. patent application Ser. No. 16/072,000, “Systems and Methods for Improving Disease Diagnosis”, for use in biological disease diagnosis. Its usage is extended in this disclosure. Note that the CSC Independent Variables are generally adjusted so that they will all have classifier related change in the same direction. In the case of cancer, they are all adjusted such that they show upregulation in the transition from not disease to cancer. If say four of the independent variables show up regulation and one is down, the down regulator is inverted. Also note, that in this case the second equation is inverted on both the ordinate and abscissa axes. This equation is then shifted horizontally and vertically such that they meet at the mid-point between the two classifier states (not-disease and disease states for biology).

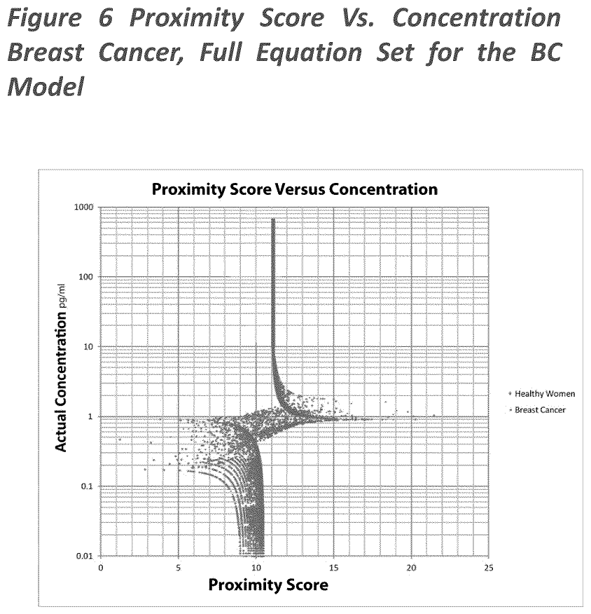

FIG. 6 shows the full set of compression equations for converting RAW concentration of il-6 to Proximity Score for the breast cancer model. Note that there are a number of equation lines (denoted by plotted data points). There is one plotted line for each value of the FCSI Independent Variable, in this case age spanning the range from 35 to 75 years of age, the target audience of the test. The mean values are shown at the far right for not breast cancer and the far left for breast cancer positive samples. The equations go to negative (not disease) and positive (disease) infinity. The software simply truncates the computed value at a convenient user selected number within the range of 0 to 5 and 15 to 20 for cases where the actual concentration is equal to the mean value for that year of age.

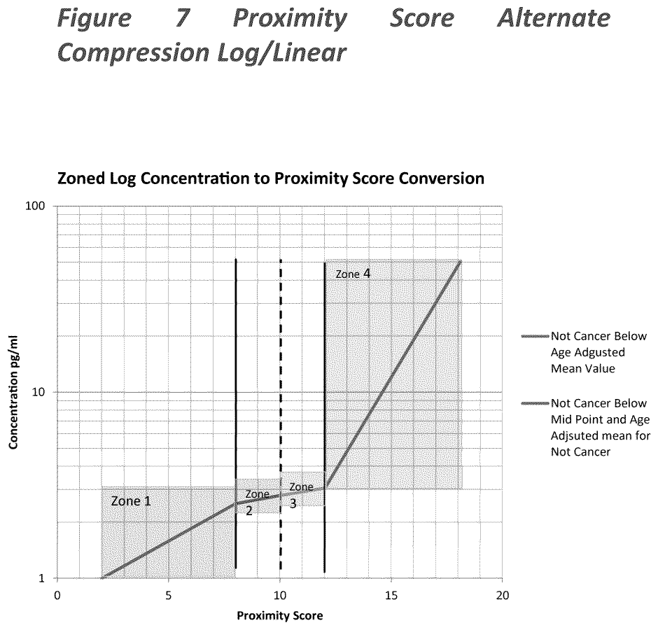

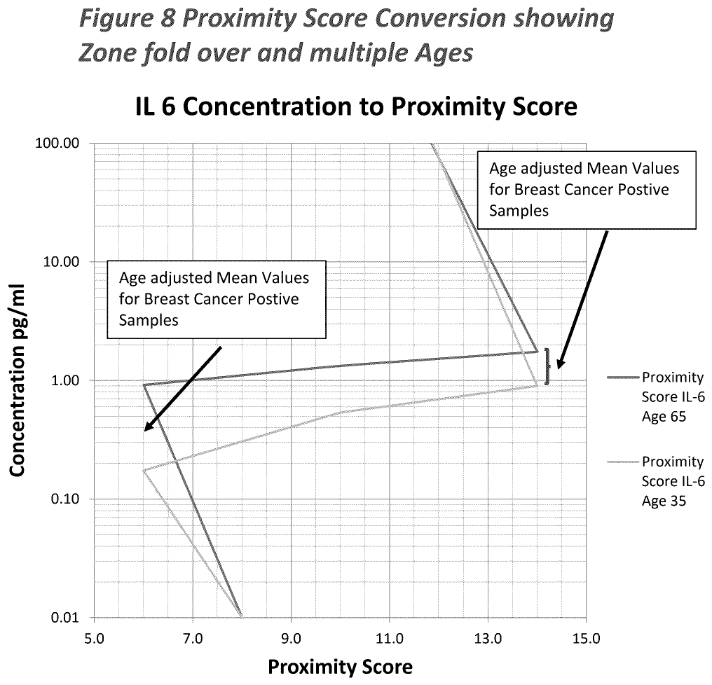

Other types of compression equations can be applied to this method, such as simpler log/linear equations (see FIGS. 7 and 8). FIG. 7 only shows one compression equation set for one FCSI Independent Variable. FIG. 8 shows two compression equation sets one for 35 years of age and the other for 65 years of age. A full set would show one equation set for each year of age that the test is designed for, as is shown in FIG. 6.

These equations selectively compress or expand measured concentration values to allow a better fit to the proximity correlation method. In biology age adjusted mean concentration values are used for the not-disease state and for the disease state. This method will consistently produce 20 to 25 points higher predictive power (sensitivity and specificity) compared to logistic regression and usually at least 10 to 15 points improvement against classic neighborhood search or SVM methods.

We have found consistently across many disease detection models that this clustering method (spatial proximity) performs far better than classifier methods that use data trending. That is especially true when coupled with the “noise suppression” (lack of specificity) steps noted above. This has been evaluated across six cancers as well as diseases such as Autism, and Alzheimer's, and infectious disease such as Lyme's Disease, and the model for credit card fraud, and airline travel satisfaction.

The exact nature of the compression equations can be adjusted for maximum predictive power. The K gain factor, and offset can be adjusted to maximize predictive power. Also, for the log/linear compression equations where the mean values, derived midpoint and bottom and top point land on the proximity score axis is adjustable for the same reason.

Signature of the Classifier State

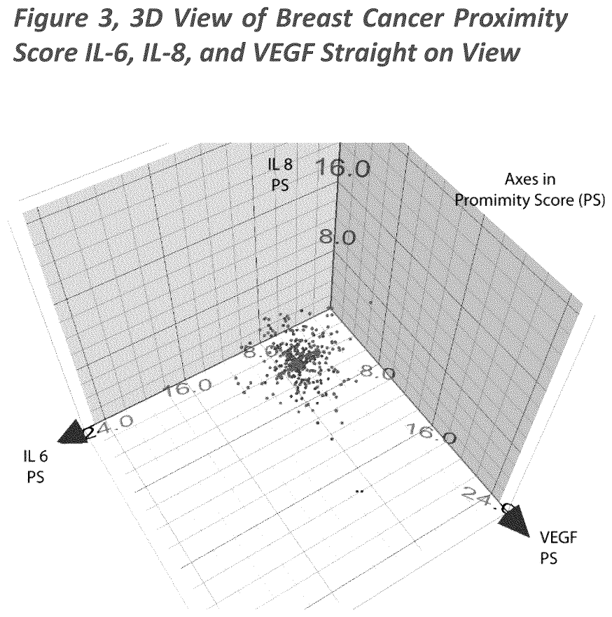

The signature of the Classifier Outcome State is the mean values of the CSC Independent Variables for both outcome states and the derived midpoint between them. The mean values are distributed across all values of the concatenated FCSI Independent Variables, three values State “A”, State “B” (or not “A”) and the midpoint for each incremental FCSI Independent Variable. When processed by the compression equations the result is a fan of equations that translate RAW independent variables into the Proximity Score. See FIG. 3 for the breast cancer case.

An important question “is this Classifier State Signature” unique to the case it is designed for? In U.S. patent application Ser. No. 14/774,491, “A Method for Improving Disease Diagnosis Using Measured Analytes,” 80 different conditions not related to the case disclosed, breast cancer, were studied in the scientific literature. The conditions were evaluated for up regulation of the biomarkers used in the breast cancer test, IL-6, IL-8, TNFa, VEGF and Kallikrein III. Only 6 were found that upregulated three of these biomarkers and only 21 upregulated only two of these. None were found that upregulated four or all five of these biomarkers.

Note also that if an EPPNS model is constructed using the four cytokines in the ovarian and breast cancer tests, IL-6, IL-8, TNFa and VEGF, the predictive power is about 98%. The reason is that the two different diseases produce a different muti-dimensional pattern in the proximity grid, a different Signature of the Classifier Outcome for breast and ovarian cancer.

The data appears to suggest that the method is robust. To be sure there could be cases where multiple diseases conspire to replicate the pattern found for the disease of interest and certain individual cases may be found that replicate the pattern of the disease of interest. Those should remain statistically low in the population.

This method depends on having a steady and consistent Classifier Signature (in biology disease/no disease) mean values. In the case of biology, a key component of the clinical laboratory operation is quality control monitoring of serum/plasma measurement equipment. The Quality Control programs residing in those machines will invariably include a month by month computation of the rolling mean values of the analytes on the test menu of the machine. If the rolling means are drifting it signals to the lab management that machine maintenance is needed. In fact, if those biological mean values are not stable, the whole edifice of clinical chemistry is in jeopardy.

Having a steady classifier signature is probably not possible in some situations outside of clinical chemistry. Perhaps equity or stock valuation trajectory is such a case where mean values of independent variables are not steady and shift with time and market conditions.

Folding Zones Improves Predictive Power

Note FIGS. 6 and 8. They both show folding of zone 1 back over zone 2 and folding of zone 4 back over zone 3. That improves predictive power consistently by 3 to 4 percent. That happens because most false placement of CSC Independent Variables, even after noise suppression and normalization, will fall in zones 2 and 3. Fewer fall in zones 1 and 4. Thus, forcing the compression equations to overlap as shown in the plot improves the false call rate as the relatively high percentage population of true calls in zone 1 are then clustered in zone 2 for the proximity scoring. The same is true of zone 4 loaded into zone 3.

Comparison of Public Domain Classifiers to Enhanced Predictive Power by Noise Suppression Classifier

Table 1 shows the invention under discussion as it compares to the 28 public domain classifiers. Table 1 shows the highest predictive power for the various public domain classifiers for each analytical example. Examples shown are for six cancers, breast, ovarian, prostate, pancreatic, non-small cell lung, and melanoma. One neurological disease autism, one auto-immune disease type one diabetes, and one infectious disease Lyme's. Also shown are two examples from finance risk of a credit card charge being fraudulent and airline travel satisfaction. The data set for the credit card fraud and airline travel case are from a public data set³,⁴ ³ From Dataset; https: //www.kaggl.com/datasets/yashpaloswal/fraud detection-credit-card?resource=download⁴ From Dataset; https://www.kaggle.com/datasets/teejmahal20/airline-passenger-satisfaction

In all cases, the EPPNS method has superior predictive power than the 28 public domain classifiers. That follows directly from the fact the public domain methods do not have a scheme to deal with the FIG. 1 type of scatter or noise in the raw data. Many sort for a line of separation between the two outcome states, using various different strategies. That line can be straight, curved or several closed loops. The worst performance is with the breast cancer case, where the Gaussian Naïve method will produce 20 more false calls out of 100 samples than the EPPNS method. The best, credit card fraud, yields only 3 more false calls than the EPPNS method, out of 100 samples. Not surprising.

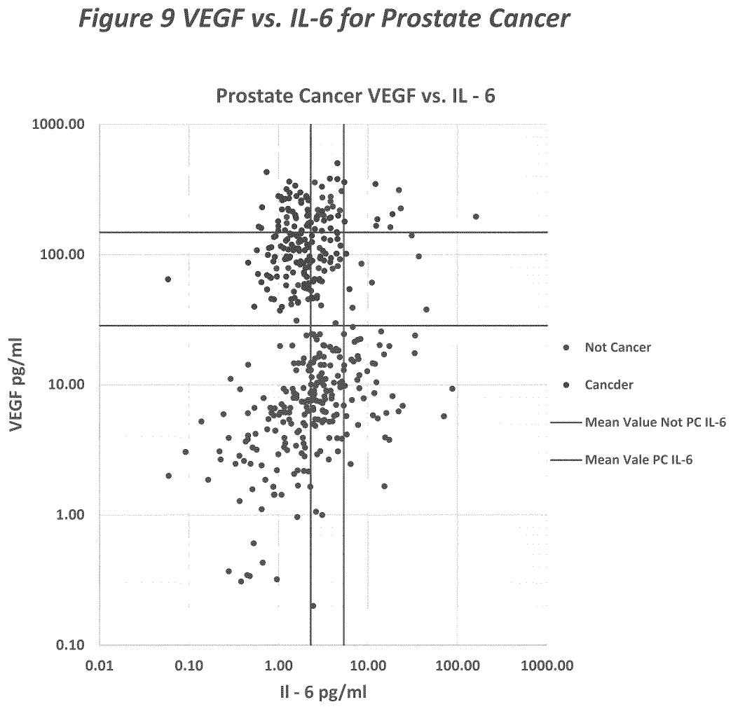

The variance in performance is quite large, from 20 missed calls out of 100 for breast cancer to only 5 for prostate cancer. This is not surprising as the ability to predict is deeply connected to the morphology of the data set (using the more general meaning of the term). FIG. 9 for prostate cancer shows graphically how the biomarker plot can show that differentiation. In the case of prostate cancer, the VEGF is reasonably good as an independent variable, thus yielding fairly good separation with one of the booster methods and with neural networks. EPPNS still outperforms conventional methods.

It is clear that public domain classifiers cannot accurately track RAW data as a measure for needed biological solutions for diagnosing disease. Also, many cases in the physical world classifier problems suffer the same noisy data that the strategies employed in these standard classifiers cannot cope with. A strategy is needed that will change the nature of the Raw data yielding a classifier scheme that will produce much higher predictive power. That strategy must encompass the “Signature of the Classifier Outcome” (the two derived mean values and midpoint) and apply the CSC Independent Variable compression and FCSI Independent Variable normalization, noted above in equations 1 and 2 or the log/linear method. FIG. 2 shows the result for the RAW data in FIG. 1 for the breast cancer case. Note that a clear delineation appears alone on both the IL-6 and VEGF axes. Actually, any of the methods that use a linear or curve-linear line of separation would work fairly well on this Proximity Score data, but not as well as the EPPNS method. The best classifier to apply remains the spatial proximity method or “nearest neighbor” method works best.

Discussion of Classifier Cases

Breast Cancer

The breast cancer case is from a blinded validation trial conducted at the Gertsen Institute in Moscow, Russian Federation. The instruments and reagents and training were supplied by OTraces, Inc. The measurement equipment was an ELISA robot programmed by OTraces to run ELISA type assays for five tumor microenvironment active biomarkers, four cytokines IL-6, IL-8, TNFα. VEGF and one tumor marker Kallikrein 3. All samples were collected and run at the Gertsen Institute and cancer treatment and research facility. The training set was 100 not cancer samples and 100 samples diagnosed with breast cancer by breast biopsy. The remaining 208 samples were the blinded validation set. The samples are shown in a bi-marker plots FIGS. 1 and 2. FIG. 1 is the raw concentrations measured and FIG. 2 shows the proximity Score after math processing. This case is very problematic for the public domain classifiers, as the raw concentrations are very scattered with showing some trend for upregulation as the cancer forms. The EPPNS method disclosed herein achieved 96.5% predictive power. The best public domain classifier Bernoulli Naïve Bayes achieved only 76.7% predictive power.

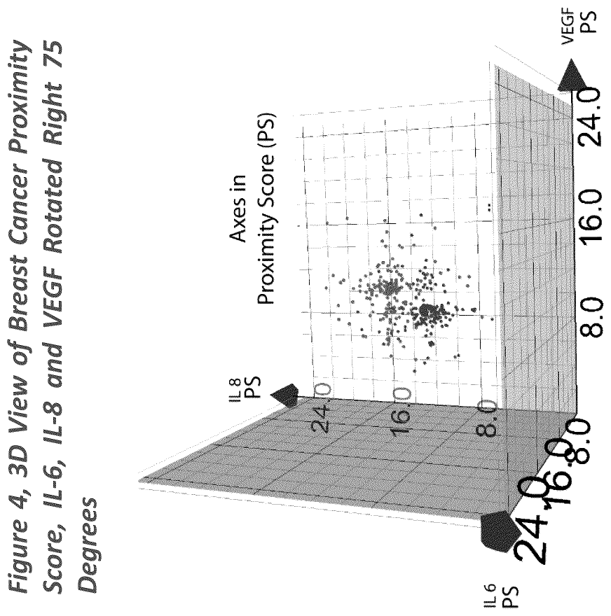

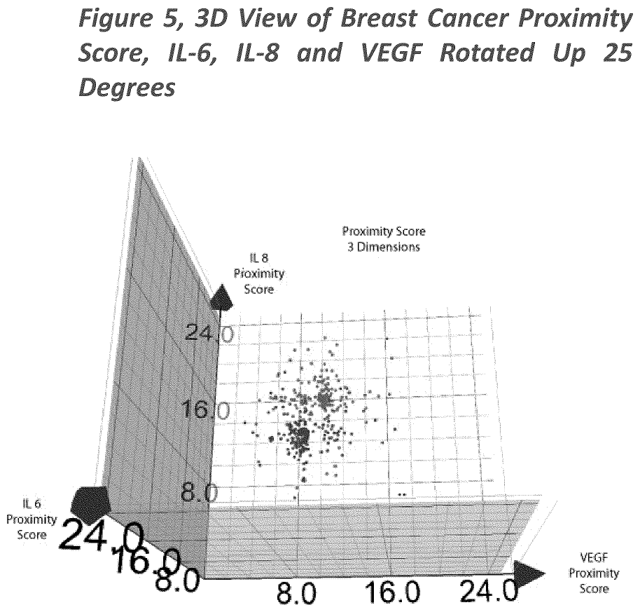

FIGS. 3, 4 and 5 show a 3D view of IL-6, IL-8 and VEGF for breast cancer showing how the proximity score biomarkers separate in multi-dimensional space. The three plots of course only show 3 of the 5 biomarkers and each biomarker adds a similar amount of separation. FIG. 3 looks down straight on the front of the plot; the biomarkers overlap. The two rotated views FIGS. 4 and 5, show the separation.

Prostate Cancer

The prostate cancer case is from a blinded validation trial conducted at Johns Hopkins Urology Center in Baltimore, Maryland. The instruments and reagents and training were supplied by OTraces, Inc. The measurement equipment was a cartridge-based immunoassay System from Protein Simple, the machine ELLA, supplied by OTraces to run immunoassays assays for five tumor microenvironment active biomarkers, four cytokines IL-6, IL-8, TNFα. VEGF and one tumor marker prostate specific antigen PSA. All prostate cancer positive samples were from the JHU serum bank and the not cancer samples were purchased commercially. The samples were run at the JHU laboratory. The training set was 100 not cancer samples and 100 samples diagnosed with prostate cancer by prostate biopsy and followed up by prostatectomy. The remaining 241 samples were the blinded validation set. FIG. 9 shows a bi-marker plot of the raw concentrations measured for VEGF and IL-6. This case is interesting in that VEGF shows a dramatic upregulation in the transition from not cancer to cancer. Also note the plot shows the overall mean values on the aggregate data for both the not cancer (blue) and cancer samples (red). The proinflammatory immune system cytokine, IL-6, shows significant down regulation. Surprising, in that cancer is a pro-inflammatory disease. This down regulation is caused by action from the tumor, secreting an anti-inflammatory cytokine. This data set shows why this biomarker set preforms fairly well with existing classifiers, with Extreme Gradient Boost Classifier achieving 94.6% predictive power. The EPPNS method disclosed herein achieved 99.8% predictive power. The ability of existing classifiers to perform well, as in this case, is highly dependent on the morphology (meaning in the classical sense) of the data set. Since VEGF has such strong and fairly clean upregulation, the nature of the data set lends itself to better predictive power with several of the common classic classifiers. Nonetheless, the EPPNS method still performs considerably better, reducing the number of false calls by a factor of 5. The morphology of this data set shows reasonable separation due to the action of VEGF. However, the EPPNS method still shows superior performance.

Melanoma

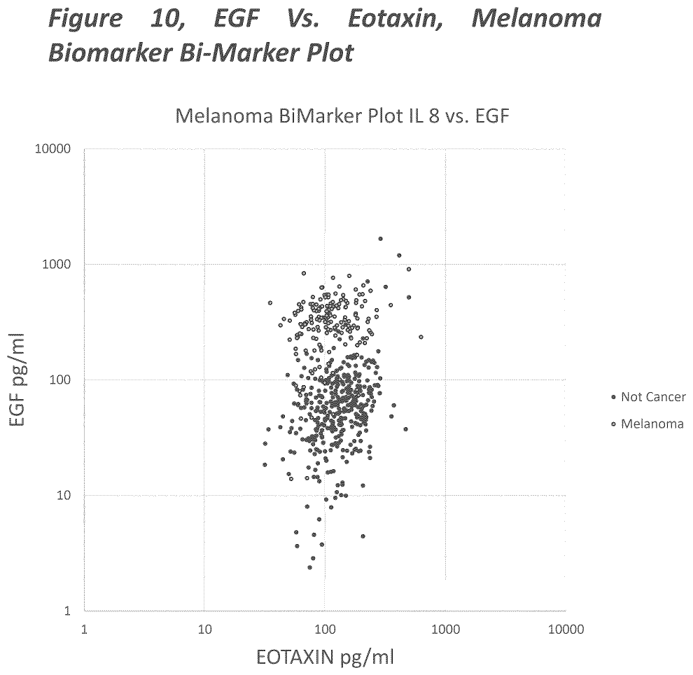

The melanoma case is from a blinded validation trial conducted at the University of Pittsburgh Luminex Core Lab. The biomarkers were measured at the Core lab. Cytokines measured were IL-8, EGF, Eotaxin, G-CSF, HGF, and IL-5. The training set was again 100/100 not cancer and cancer samples. The remaining 350 samples were used as the validation set. The best classic classifier achieved 88% predictive power and the EPPNS method 94%. FIG. 10 shows a Bi-marker plots for two Biomarkers Eotaxin and EGF. This case is similar in morphology to the prostate cancer case in that EGF upregulates to the disease state relatively crisply. Thus, common public classifiers work fairly well. The EGB Classifier achieves 93% predictive power, whereas the EPPNS method achieves 96% predictive power, with 3 fewer false calls out of 100 samples.

Other Cancers

Ovarian, non-small cell Lung cancer (NSCLC), and pancreatic cancer were analyzed from third party data sets. None of those data sets had enough samples to run a separate blind sample set, so they were validated by boot strapping. In this case, one sample is removed from the data set and then the classifier model is rebuilt without it. That removed sample is then run as a “blind” sample. That is then done for all samples in the data set. For those cases, the EPPNS method achieved about 95.5%, 95% and 98% for ovarian, NSCLC and pancreatic cancer and 90.7%, 82% and 88% for each respectively, using common classifiers.

Type One Diabetes

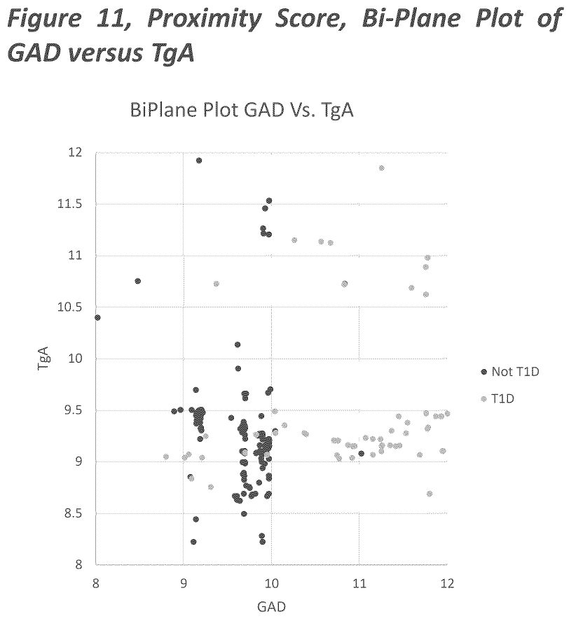

This data set came from the large TEDDY NIH study,-The Environmental Determinants of Diabetes in the Young. That study enrolled about 8500 participants, which were followed-up every six months until into the teenage years. The predictive models all are based upon determining risk on onset of the full disease 1, 3, and 5 years before full diagnosis. So, the TID positive samples all had a full positive diagnosis but the biomarker measurements were extracted from the data set 1, 3 and 5 years before the full diagnosis was made. The not TID samples were culled from test samples that never were diagnosed as positive. The data shown in the Table 1 is for the 3-year case. For that case, the EPPBS method achieved 99.7% predictive power whereas the best classical classifier achieved 91%. The biomarkers measured in the study were auto-antibodies (GADA, IA2A, mIAA, TgA) and other proteins (hbAlc, and ZNT8A). FIG. 11 shows a biomarker plot of TgA and GAD in Proximity Score, again showing the separation produced by the EPPNS method. The separation showing is not perfect but remember that these plots do not show all of the biomarkers used (6).

Other Biology Cases

The other biology cases are from third party proprietary sources.

Credit Card Fraud

The data set for this case is from a web based public source, www.kaggle.com⁵. The data set has 28 independent variables plus the amount of the fraud charge. 320 data set samples were downloaded from the web site. The charge amount was used as the FCSI variable and only 6 of the CSC Independent Variables were used in the model to avoid overfit errors (6 times 25=150 or 150/150 training set is warranted). ⁵ https: //www.kaggl.com/datasets/yashpaloswal/fraud detection-credit-card?resource=download

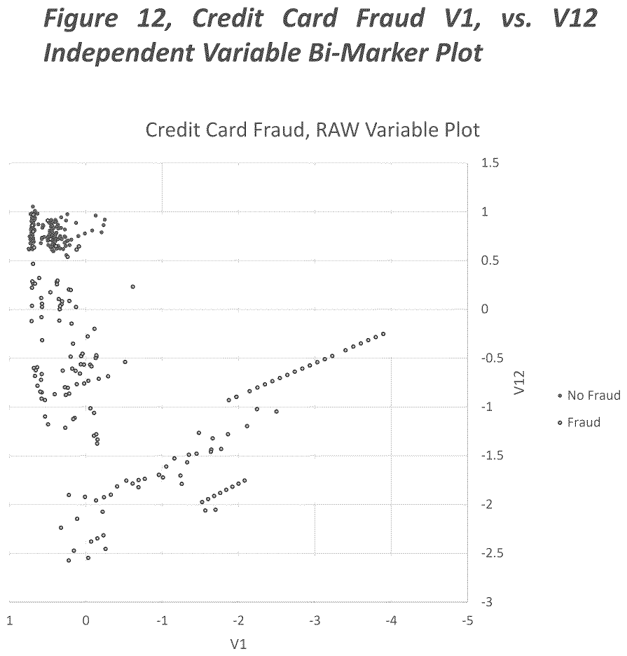

FIG. 12 shows a Bi-marker Plot of two of the CSC Independent Variables., V1 versus V12. The bi-marker is not named in this publicly released data set and not described in the public release; however, they are attributes of the transaction, the source of the transaction and the card holder. The EPPNS method reduces the number of false calls by 5 out of 100 samples. It's not surprising that the morphology of this data set shows good separation. The CSC Independent Variables are carefully chosen to maximize performance with public domain classifiers. The financial implications of credit card fraud are significant, and the CSC Independent Variables are designable to a degree by the model builder. That is not the case with biological biomarkers. They come with the physicality of the patient. The best classic classifier, Neural Networks achieved 95% predictive power and the EPPNS method achieved 98.4% predictive power.

Air Travel Satisfaction

The data set source for the airline satisfaction case is from a public source, www.kaggle.com⁶. 6 CSC Independent Variables were used, appropriate for the 320 samples used in the training set: cleanliness, flight distance, inflight entertainment, on-board service, online boarding, and seat comfort. The best performing common classifier was the random forest classifier yielding 85.4% predictive power. The EPPNS method delivered 96% predictive power and 11 less false calls. ⁶ https://www.kaggle.com/datasets/teejmahal20/airline-passenger-satisfaction

Age-Adjusted Function

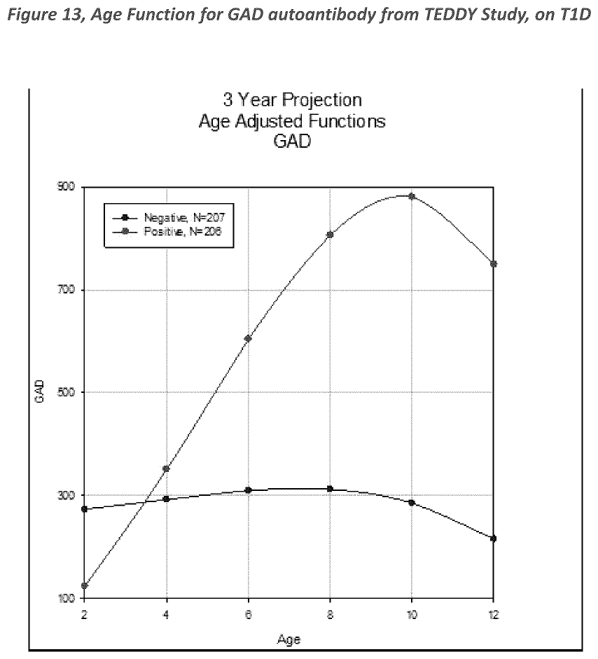

FIG. 13 shows an example of the FSCI Independent Variable variation for the two binary classifier outcomes for the GAD autoantibody measured in the TEDDY study for the type one diabetes project. As can be seen, the mean CSC Independent Variable (concentration) shifts dramatically as the patient cohort ages, the FCSI Independent Variable used. That drift if not normalized will smear out the raw independent variables with respect to the all-important disease signature. In fact, the disease positive (red) and disease negative (blue) overlap at early ages. That shifting and overlap is typical of all biology-based biomarkers used to date in various classifiers methods and thus must be dealt with routinely for best accuracy.

Non-Binary Outcome Predictions

This method can also be used to make outcome predictions in cases where the expected outcomes are not binary but are three or more. This method was used to predict breast cancer stage from the Gertsen Institute study where the stages detected in biopsy were stage 1, 2, 3, and 4. In this case, several binary models were created by grouping the cancer positive samples by stage into binary models. The groups were 1) stage 1 and stage 2, 3, and 4; 2) stage 2 and stage 1, 3, and 4; 3) stage 3, and stage 1, 2, and 4; and 4) stage 4, and stage 1, 2, and 3. Those four models were then constructed using the EPPNS method. Each model produced two scores, one for each side of the groups. Those were then deconvoluted by analyzing factors from the number of stage types in each group. Out of 186 total samples, the set of deconvoluted models produced 185 correct results and 1 false call, or 99.5% predictive power.

Usage of Independent Variable and Selection as CSC and FCSI Independent Variable Types

Table 2 shows the examples cases and the variable types used and how they are parsed out into the categories of CSC and FCSI Independent Variables. As can be seen, CSC Independent Variables used have been metabolites, peptides, Proteins RNA (quantitative) Mutant DNA, Methylated DNA and surveys or questionnaires that are digitized or scored for the classifier outcome type, disease for biology. The FCSI variables used are Natural or inherited DNA, Age, Body Mass Index, Race, geographical location, menopause status (pre, peri or post) and for the case outside of biology the credit card fraud, the amount of the charge. Age was used for the case of airline satisfaction. There may be cases where a variable may land in either group, CSC or FCSI Independent Variables. Body mass index could be a causative or reactive result of type one diabetes disease. In these cases, the variable should be tested for placement in both categories, for best predictive power.

The foregoing description and drawings should be considered as illustrative only of the principles of the invention. The invention is not intended to be limited by the preferred embodiment and may be implemented in a variety of ways that will be clear to one of ordinary skill in the art. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. A computer-implemented method for using an evaluative model to indicate a probability of a Classifier Outcome for a Classifier Condition Under Evaluation in a Sample Under Evaluation under examination, the method comprising:
receiving a first set of CSC Independent Variable values of a first data point from the Classifier Condition Under Evaluation from a first set of samples from Samples Under Evaluation with a Classifier State “B” for the Classifier Condition Under Evaluation;
receiving a second set of CSC Independent Variable values of the first data point from the Classifier Condition Under Evaluation from a second set of samples from Samples Under Evaluation with a Classifier State “A” for the Classifier Condition Under Evaluation, wherein the first set and second set of samples comprise a training set of samples;
calculating a mean value of the CSC Independent Variable values of the first data point from the Classifier Condition Under Evaluation from the first set of CSC Independent Variable values;
calculating a mean value of CSC Independent Variable of the first data point from the Classifier Condition Under Evaluation from the second set of CSC Independent Variable values; computing a midpoint value of CSC Independent Variable between the mean value of the first set of CSC Independent Variable values and the mean value of the second set of CSC Independent Variable values;
calculating a first proximity score representing the mean value of CSC Independent Variable of the first set of data points from the Classifier Condition Under Evaluation, said calculation comprising normalizing FCSI Independent Variable drift in transition between the Classifier Outcome for the Classifier Condition Under Evaluation and non-disease state for the Classifier Condition Under Evaluation and dampening outlier CSC Independent Variables in the training set of samples;
calculating a second proximity score representing the mean value of CSC Independent Variable of the second set of data points from the Classifier Condition Under Evaluation, said calculation comprising normalizing FCSI Independent Variable drift in transition between the Classifier Outcome for the Classifier Condition Under Evaluation and non-disease state for the Classifier Condition Under Evaluation and dampening outlier CSC Independent Variables in the training set of samples;
deriving a midpoint proximity score representing the derived midpoint of the mean values of CSC Independent Variable of the first and second sets of data points from the Classifier Condition Under Evaluation; and
mapping the CSC Independent Variables of the training set of samples into a range of proximity scores between the first proximity score and the second proximity score to complete the evaluative model, wherein the evaluative model identifies the Classifier Outcome for the Classifier Condition Under Evaluation of a Sample Under Evaluation under examination.

2. The computer implemented method of claim 1, wherein the training set of samples includes at least one of blood samples, urine samples, and tissue samples.

3. The computer-implemented method of claim 1, wherein the calculated mean value for CSC Independent Variable for the first set of samples and for the second set of samples is FCSI Independent Variable-adjusted.

4. The computer-implemented method of claim 1, wherein the training set of samples includes an equal number of State “A” samples and State “B” samples.

5. The computer implemented method of claim 1, wherein mapping the CSC Independent Variables of the training set of samples includes mapping the CSC Independent Variables into proximity score zones, wherein the proximity zones further comprise:
a first zone with proximity scores corresponding to a CSC Independent Variable of the first data point from the Classifier Condition Under Evaluation higher than the mean value of CSC Independent Variable of the first set of samples and lower than the mid-point; and
a second zone with proximity scores corresponding to a CSC Independent Variable of the first data point from the Classifier Condition Under Evaluation higher than the mid-point and lower than the mean value of CSC Independent Variable of the second set of samples.

6. The computer implemented method of claim 1, wherein calculating a range of
proximity scores further comprises:
mapping CSC Independent Variables of the training set of samples below the first proximity score; and mapping CSC Independent Variables of the training set of samples above the second proximity score, wherein the mapping of CSC Independent Variables of the training set of samples creates proximity score zones.

7. The computer implemented method of claim 6, wherein mapping the CSC Independent Variables of the training set of samples comprises mapping the CSC Independent Variables into proximity score zones, wherein said proximity score zones further comprise:
a first zone with proximity scores corresponding to a CSC Independent Variable of the first data point from the Classifier Condition Under Evaluation lower than the mean value of CSC Independent Variable of the first set of samples;
a second zone with proximity scores corresponding to a CSC Independent Variable of the first data point from the Classifier Condition Under Evaluation higher than the mean value of the first set of samples but lower than the midpoint value of CSC Independent Variable and wherein the second zone is located next to the first zone;
a third zone with proximity scores corresponding to a CSC Independent Variable of the first data point from the Classifier Condition Under Evaluation higher than the midpoint value of CSC Independent Variable and lower than the mean value of the second set of samples and wherein the third zone is located next to the second zone; and
a fourth zone with proximity scores corresponding to a CSC Independent Variable of the first data point from the Classifier Condition Under Evaluation higher than the mean value of the CSC Independent Variable of the second set of samples and wherein the fourth zone is located next to the third zone.

8. The computer implemented method of claim 1, wherein the mapping of the CSC Independent Variables of the training set of samples into the range of proximity scores further comprises:
inverting a range of CSC Independent Variable values of the training set of samples as the CSC Independent Variables are mapped into the range of proximity scores.

9. The computer implemented method of claim 1, wherein the mapping of the
CSC Independent Variables of the training set of samples into the range of proximity scores further comprises:
at least one of compressing and expanding a range of CSC Independent Variable values of the training set of samples as the CSC Independent Variables are mapped into the range of proximity scores.

10. The computer-implemented method of claim 1, further comprising:
performing steps a-i recited in claim 1 for a second data point from the Classifier Condition Under Evaluation;
mapping the CSC Independent Variables of the training sets of samples for the first data point from the Classifier Condition Under Evaluation and the second data point from the Classifier Condition Under Evaluation into an orthogonal multi-dimensional grid, wherein the axes of the grid include the CSC Independent Variable of the first data point from the Classifier Condition Under Evaluation, the CSC Independent Variable of the second data point from the Classifier Condition Under Evaluation, and the proximity scores of the first data point from the Classifier Condition Under Evaluation and the second data point from the Classifier Condition Under Evaluation;
dividing the multi-dimensional grid into grid sections boxes to be scored for the Classifier Condition Under Evaluation; and
scoring each individual grid section box in the multi-dimensional grid based upon the proximity of each grid section box to a predetermined number of training set samples.

11. The computer-implemented method of claim 10, further comprising:
compiling multi-dimensional grid scores at each training set location point; and calculating a training set accuracy score based upon the compiled multi-dimensional grid scores;

12. The computer-implemented method of claim 10, wherein the predetermined number of training set samples includes about five to fifteen percent (5-15%) of the closest training set samples to each box.

13. The computer-implemented method of claim 12, wherein scoring each individual box in the multi-dimensional grid includes:
calculating a count number of about five to fifteen percent (5-15%) of the closest training set samples that are samples from Samples Under Evaluation with a Classifier State “A” for the Classifier Condition Under Evaluation;
calculating a count number of about five to fifteen percent (5-15%) of the closest training set samples that are samples from Samples Under Evaluation with a Classifier State “B” (or Not-State “A”) for the Classifier Condition Under Evaluation;
comparing the determined count numbers; and
scoring each individual box in the multi-dimensional grid as disease or not-disease based upon the comparison of the determined count numbers.

14. The computer-implemented method of claim 10, wherein the predetermined number of training set samples includes about three to ten percent (3-10%) of the closest training set samples to each box.

15. The computer-implemented method of claim 10, wherein scoring each individual box in the multi-dimensional grid further comprises:
slicing the multidimensional grid into planes that are coincident with the axes of the first data point from the Classifier Condition Under Evaluation CSC Independent Variable and proximity score and the second data point from the Classifier Condition Under Evaluation CSC Independent Variable and proximity score;
calculating a count number of about three to ten percent (3-10%) of the closest training set samples that are samples from Samples Under Evaluation with a confirmed Classifier State “A” for the Classifier Condition Under Evaluation;
calculating a count number of about three to ten percent (3-10%) of the closest training set samples that are samples from Samples Under Evaluation with a Classifier State “B” (or Not-State “A”) for the Classifier Condition Under Evaluation;
comparing the determined count numbers;
scoring each two-dimensional box in each of the planes as disease or not-disease based upon the comparison of the determined count numbers;
calculating a plane score for each of the planes based on the scoring of each two dimensional box in each of the planes; and
calculating a total probability of a Classifier Outcome score by combining the plane scores.

16. The computer-implemented method of claim 15, further comprising:
applying a weighting factor to each of the plane scores.

17. The computer-implemented method of indicating the probability of a Classifier Outcome of claim 1, further comprising:
normalizing the indication of the probability of a Classifier Outcome for the Classifier Condition Under Evaluation based on the FCSI Independent Variable of the Sample Under Evaluation under examination.

18. The computer-implemented method of claim 17, further comprising:
calculating mean values of CSC Independent Variable of the first data point from the Classifier Condition Under Evaluation for a predetermined number of FCSI Independent Variables of Samples Under Evaluation with the Classifier State “B” (or Not-State “A”) for the Classifier Condition Under Evaluation and for a predetermined number of FCSI Independent Variables of Samples Under Evaluation with the confirmed Classifier State “A” for the Classifier Condition Under Evaluation; and
converting the determined values of CSC Independent Variable to proximity scores, wherein the proximity scores do not have an FCSI Independent Variable related bias.

19. The computer-implemented method of claim 18, wherein determining mean values of CSC Independent Variable of the first data point from the Classifier Condition Under Evaluation for a predetermined number of FCSI Independent Variables of Samples Under Evaluation with the Classifier State “B” for the Classifier Condition Under Evaluation and for Samples Under Evaluation with the confirmed Classifier State “A” for the Classifier Condition Under Evaluation further comprises:
normalizing a CSC Independent variable-FCSI Independent variable shift in the mean values; and
normalizing the midpoint value of CSC Independent Variable between the mean value of CSC Independent Variable of the first data point from the Classifier Condition Under Evaluation for Samples Under Evaluation with the confirmed Classifier State “A” for the Classifier Condition Under Evaluation and the mean value of CSC Independent Variable of the first data point from the Classifier Condition Under Evaluation for Samples Under Evaluation with the Classifier State “B” (or Not-State “A”) for the Classifier Condition Under Evaluation.

20. The computer-implemented method of claim 19, wherein the training set of samples includes samples from Samples Under Evaluation within a predetermined range of FCSI Independent variables.

21. The computer implemented method of claim 1, where in, a computer-implemented method of creating a Classifier Outcome from a model for the Classifier Condition Under Evaluation that indicates a probability of a Classifier Outcome state (State “A” or State “B” (or Not State “A”)) in a Classifier Condition Under Evaluation under examination, the method comprising:
a. an array of independent variables defined that could have a predictive value using a machine learning classifier (Machine Learning).
b. dividing the independent variable array into two classes:
1) Classifier State Coupled (CSC) Independent variables;
2) Fixed Classifier State Independent (FCSI) or Concatenated multiple FCSI Independent variables into one set;
3) wherein, the mean values for CSC Independent Variables computed in claim 1 are specific to each individual value of each FCSI Independent Variable
4) wherein, a function relating each independent value of the FCSI Independent Variable to the three CSC Independent Variable mean values, State “A”, State “B” (or Not State “A”) and the midpoint is determined;
5) where in, each function is used in the compression equations for each zone to normalize the resulting proximity score, by having the resulting proximity score being equal for all values of each of the three FCSI Independent Variable mean values all having in resulting Proximity Score be equal for each Specific FCSI Independent Variable mean value.

22. The computer implemented method of claim 7, where in, the CSC Independent variables within the Zones are not monotonic;
a. Zone 1 is folded back over the CSC Independent variables of zone 2 such that values of the proximity score resulting from the CSC Independent variable conversion to proximity score for values within zone 1 overlap those in zone 2.
b. Zone 4 is folded back over the CSC Independent variables of zone 3 such that values of the proximity score resulting from the CSC Independent variable conversion to proximity score for values within zone 4 overlap those in zone 3.

23. The computer implemented method of claim 1, where in the method is applied to classifiers used in:
a. clinical determinations for animals and plant in disease identification;
b. image processing, wherein the method is used in identification of image content;
c. financial transactions, wherein the character of transactions or predictions of outcomes based on the transactions are desired; or
d. an application in which an outcome prediction is based upon sample attributes.

24. The computer implemented method of claim 1, where in the method is applied to classifier applications with more than two outcome predictions are needed.
